(19) United States
(12) Patent Application Publication
(10) Pub. No.: US 2011/0208358 A1
(43) Pub. Date: Aug. 25, 2011

(54) APPARATUS FOR SPLASH ZONE OPERATIONS

(76) Inventors: Arve Gjelsten, Bolsoya (NO); Jon Anders Haegstad, Heimdal (NO); Stale Karlsen, Tiller (NO); Geir Ingar Bjornsen, Trondheim (NO); Bernt Schjetne, Trondheim (NO); Martin Hasle, Trondheim (NO)

(21) Appl. No.: 13/001,836

(22) PCT Filed: Jul. 2, 2009
(86) PCT No.: PCT/NO2009/000249

§ 371 Date: Apr. 20, 2011

(30) Foreign Application Priority Data
Jul. 2, 2008 (NO) 20082941

(51) Int. Cl. B25J 13/08; B25J 19/04

(52) U.S. Cl. 700/259; 901/44; 901/47

(57) ABSTRACT

System for maintenance and inspection of structures located in hard to reach places, using a remote controlled arm that consists of arrangement for fixing said remote controlled arm to the structure, said remote controlled arm consists of at least two joints, said remote controlled arm has the ability to change working equipment, said remote controlled arm has a camera, said remote controlled arm is controlled from a control centre.

### TECHNICAL FIELD

This invention regards an apparatus for splash zone operations and more particularly to a multi purpose robotic arm for maintenance and inspection of hard to reach places on an offshore installation like an ocean rig or a vessel.

### BACKGROUND

Offshore installations are on a daily basis exposed to some of the worst weather conditions in the world. Because of the harsh weather conditions, the need for inspections and maintenance work on these installations are a continually ongoing task. In today's situation the maintenance work is done either by personnel or ROV's, but because of the heavy weather restrictions concerning the protection of personnel and equipment the amount of tasks that can be done in certain areas on the installation is very limited. This means that maintenance and inspection in these areas is very hard and the need for work here is very high.

One of these areas is the splash zone, the splash zone is the zone from sea level and down to where the wave loads is a substantial factor.

For floating and jack up installations it is possible to take them to dock to do maintenance, this is, however, extremely expensive due to lost production and the cost of moving the installation.

Permanent installations have today only the method mentioned earlier which are either divers or remote operated vehicles. All these methods are expensive, dangerous and limited due to the cost of men and machines.

This means that today there are no alternatives for maintenance and inspection in the splash zone that are safe for personnel and at the same time reduces the cost and the time consumed.

### SUMMARY

An object of the present invention is to solve the problems mentioned earlier and other limitations of the conventional solutions for maintenance and inspection of offshore installations.

The invention described in the independent claims and the thereto dependent claims, describe a mechanical access arm, connected to the main structure of the offshore installation, the arm can either be connected by a mechanical, magnetic, pneumatic and hydraulic way of fixing the arm to the structure or by any other kind of fixation device imaginable. For further stabilisation of the mechanical arm, the fixation device has at least one adjustable support beam attached to it that protrudes downward and works as a lever reducing the amount of stress both in parallel and perpendicular direction put on the structure at the fastening point.

Further the mechanical access arm is designed to penetrate the sea surface, and operate sub surface during worse weather conditions and wave loads significantly bigger than conventional techniques can handle.

The access arm is jointed in at least two places which make it easy to manipulate so that it reaches all places within the range of the arm. Further these joints make it easy to fold the access arm together so that it is easier to transport and reattach in another place.

At the end of the access arm there are mounted a working platform with changeable manipulator arms capable of performing different kind of operations. The fact that it is changeable means that it can either have a mechanical unit on the end for performing maintenance operations like, grinding, cutting and drilling, etc. It also makes it capable of performing advanced inspection work by placing inspection equipment at the end that includes but is in no way limited to, equipment for visual inspection, x-ray- and eddy current equipment.

The access arm and the fixation device is preferably mounted on a horizontally, but can also be mounted at an angle if there is no horizontal place to be found to place the system.

Further the access arm and the manipulator arm include a CCTV system for full video surveillance of the working operation so that all the operations can be done remotely. The CCTV system is also equipped with lights for illumination of the working space during night operations or operations under water.

The system has a control centre located on top of the offshore installation where personnel can perform the required tasks free from any danger and without any regards to the weather. This control centre has the complete control and manipulation of the system via screens and controls and a computer control unit to remotely operate the equipment. This control centre is also where the arm gets power for movement and the performance of all the equipment.

The installation of the equipment can be based on e.g. advanced rigging and rope access techniques or other kinds of portable equipment for fixing the arm to the structure. This means that the fixing of the arm does not relay on the permanent lifting equipment found on the offshore installation. This gives it a unique flexibility that gives it the opportunity to be operable regardless of other equipment that may be found on the installation.

### BRIEF DESCRIPTION OF THE DRAWINGS

FIG. 1 shows an embodiment of the invention in operation, mounted on an offshore installation.

FIG. 2 shows a detailed view of the same embodiment as in FIG. 1.

FIGS. 3 and 4 show a detailed view of the fixation device with support beam, and also a detailed view of a joint in connection with the fixation device.

FIG. 5 shows a detailed view of the joint separating the access arm in an inner and an outer arm.

FIG. 6 shows a detailed view of the working platform with an inspection unit mounted on one end of the access arm.

FIG. 7 shows a detailed view of the working platform with a maintenance unit mounted on one end of the access arm.

FIG. 8 shows a detailed view of the control room of the system.

FIG. 9 shows an embodiment of how the arm is installed on the offshore installation.

### DETAILED DESCRIPTION

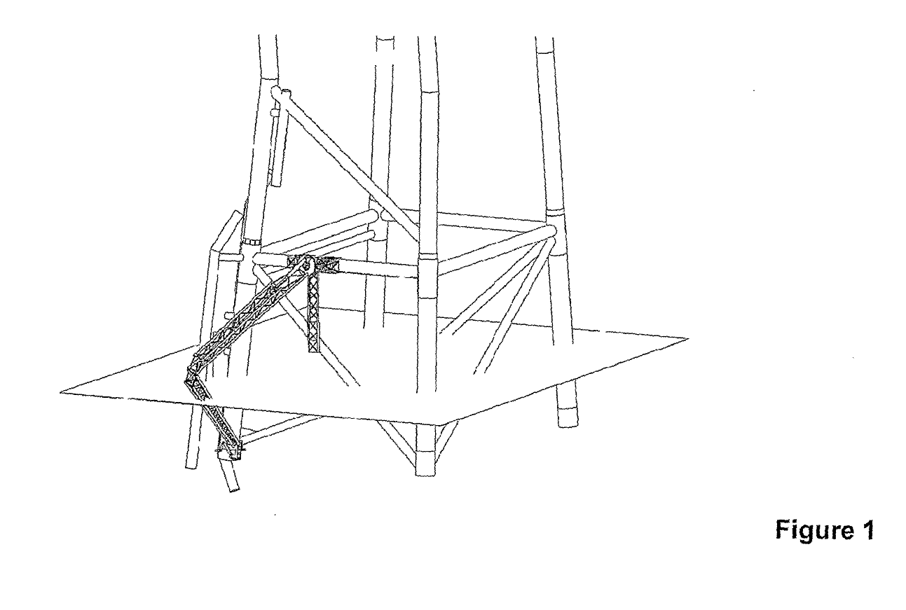

FIG. 1 shows an embodiment of the invention in operation, here we see one end of the access arm mounted on a jacket structure on a permanent offshore installation. The access arm has a support beam protruding down giving extra support and works as a lever so that the fixing device on the end of the access arm does not destroy the structure it is mounted on. Further we see how the access arm is jointed in the middle making the access arm consist of two arms, an inner arm and an outer arm. The access arm is also jointed at the fixing device giving the access arm an action radius of the full length of the arm. These to joints give the access arm an extra flexibility making it possible to reach all destinations within the full length of the arm. Further we can see how the manipulator arm is working beneath the surface of the ocean.

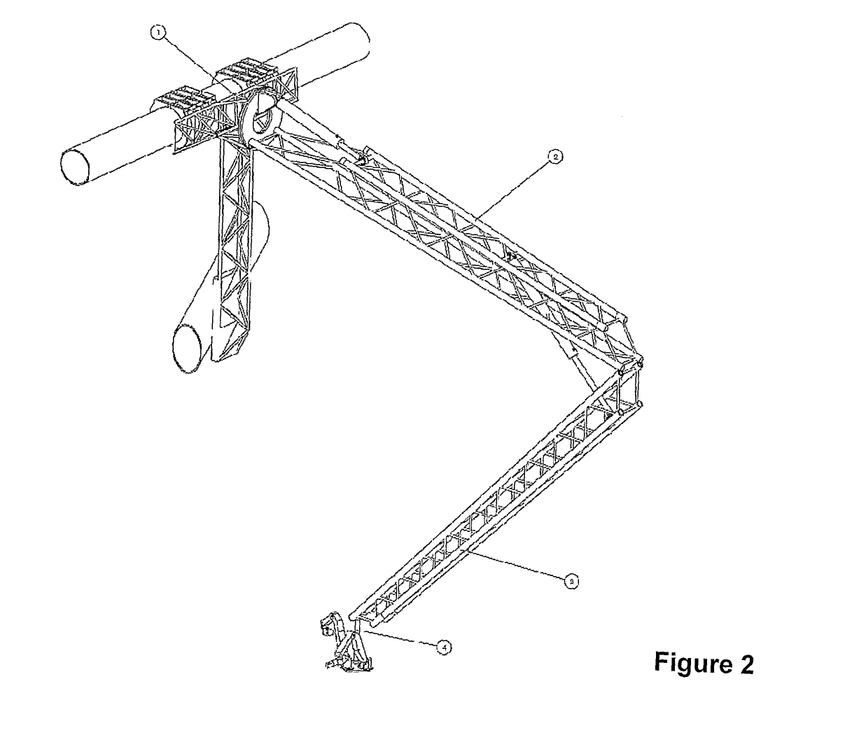

FIG. 2 shows a detailed view of the main components of the invention. It consists of a fastening point [1] to the main structure. In this embodiment the fastening point consists of two clamps that are set around the jacket structure and fastened with bolts. Using two sets of clamps gives the fixing device extra support against forces working parallel to the two fastening points. The fastening points can consist of at any number of clamps and the fastening mechanism can be any kind of method for fastening the access arm to the main structure, e.g. mechanical, magnetic, pneumatic or a hydraulic mechanism. In FIG. 2 the fastening point of the access arm is above the water, but the arm can just as well have a fastening point that is below the sea level. In this embodiment the arm is made of truss work which is light weight and strong, but it can also be made of any other form of hard and resistant material. Further the arm has the ability to be extended using a telescopic extension of the arm.

A working platform [4] is mounted to the front of the access arm. The working platform is connected to the access arm in this embodiment by, a mechanical and hydraulic joint, but any other form of connection can be used. The working platform can either be set to be in a horizontal position at all time or it can be tilted and moved around by remote control from the operating room.

Further it can be seen in FIG. 2 a support beam consisting of an arm made of truss work with a padded section, in form of a bumper plate, at the end that rests on a below lying structure. This support beam reduces the stress on the structure from the forces working perpendicular to the fastening points. The support beam can be made of a range of different materials and it can even be more than one support beam placed at an angle to each other.

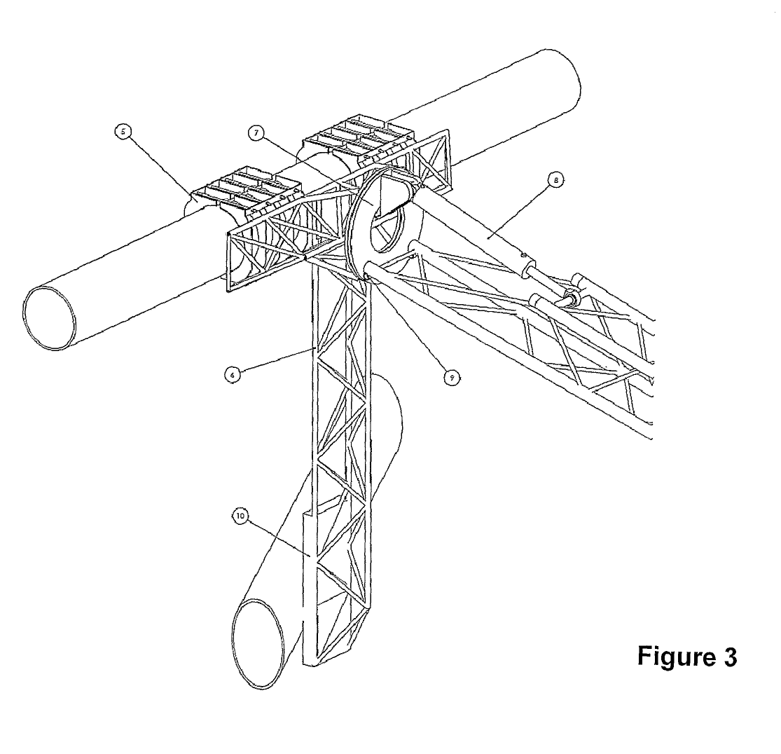

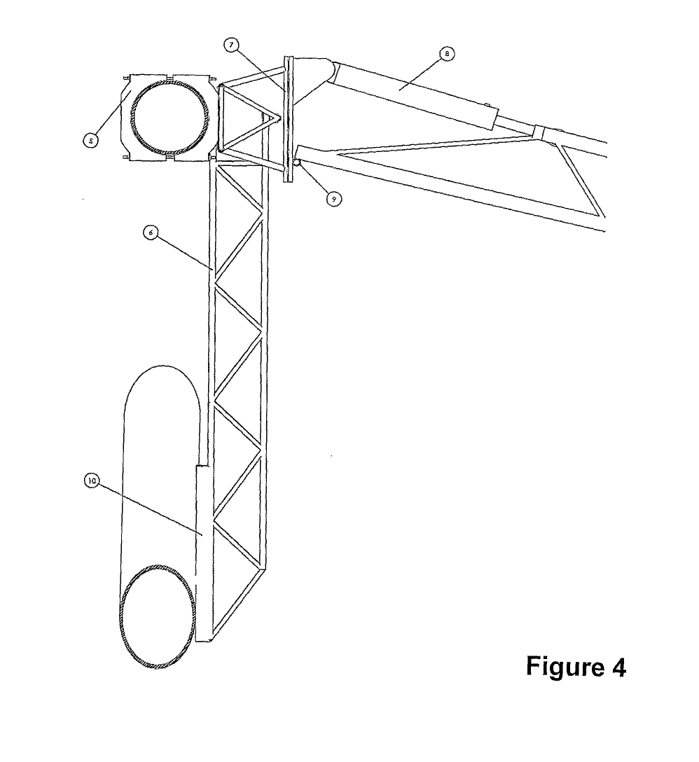

FIG. 3 and FIG. 4 show detailed pictures of the mechanical fastening mechanism. The mechanism consists of two bolted clamps [5] connected with a T-shaped structure [6]. The two clamps will take moment perpendicular to the main platform structure. The stem of the T is strapped to is an additional structure by jacking straps to take moment forces along the main platform structure. A slewing ring [7] connects the access arm to the T-structure. The movement of the joint is operated by at least one hydraulic cylinder [8]. The access arm is connected to the slewing ring [7] by slide bearings [9]. A bumper plate [10] is attached to the stem of the T to prevent mechanical damage of the structures.

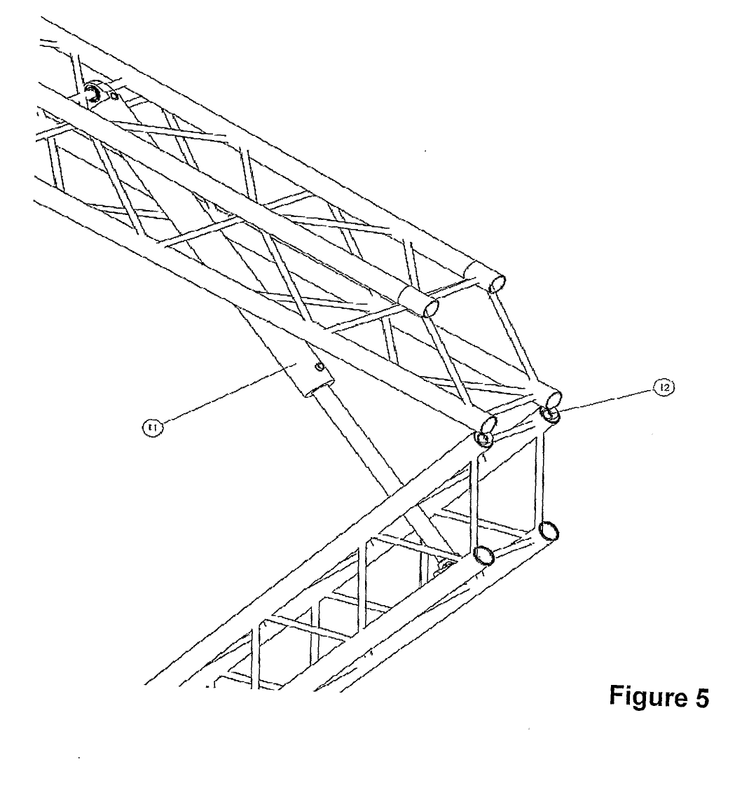

FIG. 5 shows the joint between the inner arm [2] and the outer arm [3]. The movement of the arm is performed by a hydraulic cylinder [11], and the arms are connected by slide bearings [12].

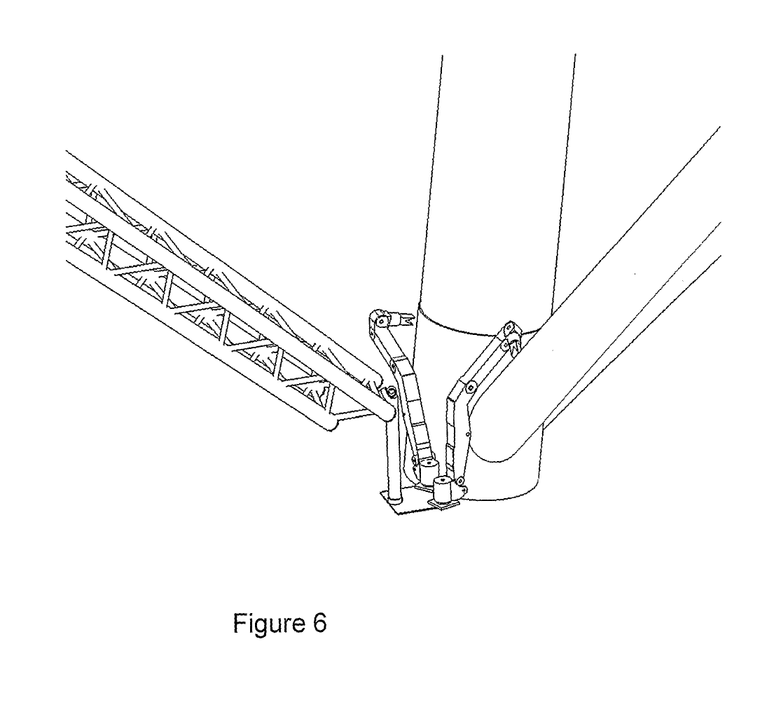

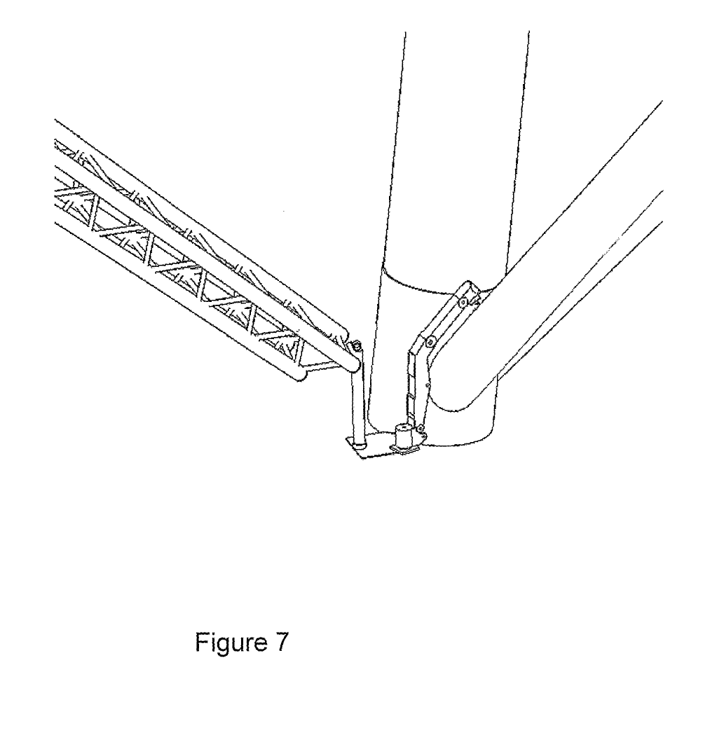

FIG. 6 and FIG. 7 show a detailed picture of the access arm performing work on and sub sea offshore structure. On the working platform there are mounted at least one manipulator arms [4]. The manipulator arms perform mechanical operations, including, but not limited to, grinding, cutting, drilling, etc. The system is also designed to perform inspection, including but not limited to, visual inspection, x-ray and eddy current.

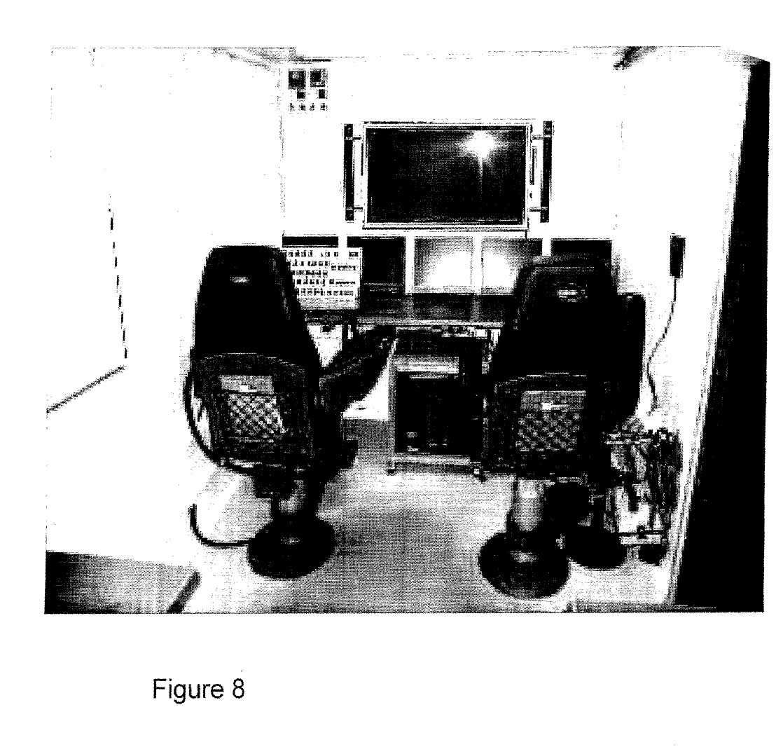

FIG. 8 gives a view of the top side platform with the control room, the control room is the centre of operation and is where the arm is controlled and is the supplier of power to the access arm and the work platform. The signalling that controls the operation can either be via a wire or it can be wireless.

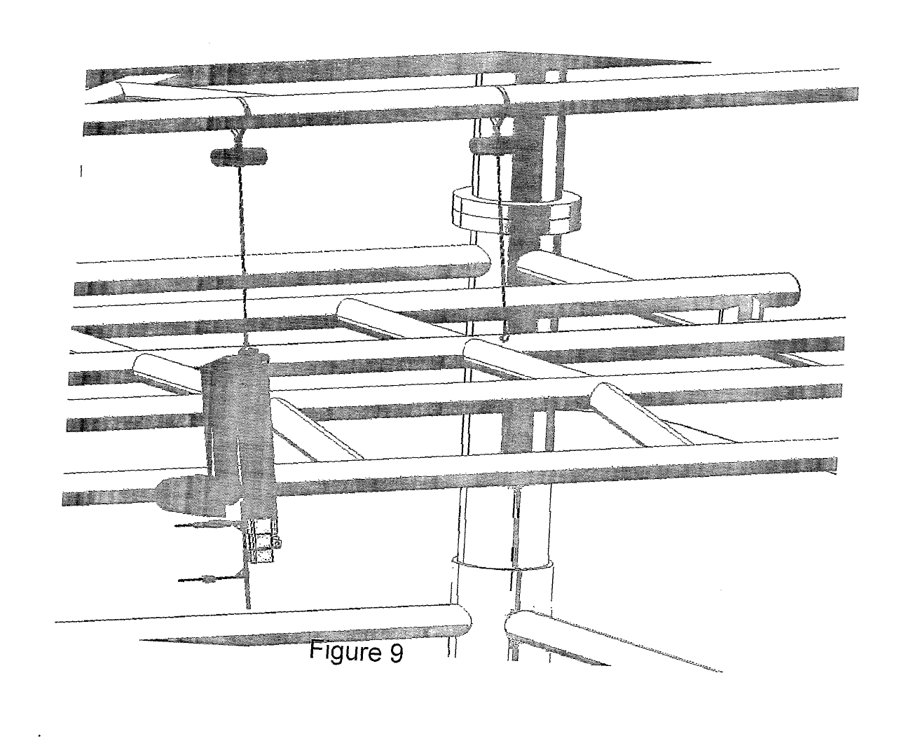

FIG. 9 shows how the arm is installed on the offshore installation, as it can be seen in this embodiment it can be used a system of ropes and pulleys, but it can also be to used other types of rigging equipment.

1. System for maintenance and inspection of structures located in hard to reach places, comprising:
a remote controlled arm that has the ability to change working equipment, wherein said remote controlled arm has a camera and said remote controlled arm is controllable from a control centre,
an arrangement for fixing said remote controlled arm to a structure, and
at least two joints, wherein an inner joint is a slewing ring capable of rotating the entire arm, and an outer joint is a hinged joint that separates the arm into an inner and outer arm.

2. System for maintenance and inspection of structures according to claim 1, wherein said inner joint connects the remote controlled arm to the arrangement for fixing said arm to a structure.

3. System for maintenance and inspection of structures according to claim 1, wherein said remote controlled arm is connected to the slewing ring by slide bearings and at least one hydraulic cylinder.

4. System for maintenance and inspection of structures according to claim 1, wherein said arrangement for fixing said arm to a structure consists of at least one fixing point.

5. System for maintenance and inspection of structures according to claim 1, wherein said arrangement for fixing said remote controlled arm to the structure has at least one support beam and said support beam has an adjustable length.

6. System for maintenance and inspection of structures according to claim 5, wherein said at least one support beam has an adjustable angle.

7. System for maintenance and inspection of structures according to claim 1, wherein said arm has an adjustable length.

8. System for maintenance and inspection of structures according to claim 1, wherein said working platform can change working equipment for performing both maintenance and inspection task.

9. System for maintenance and inspection of structures according to claim 1, wherein said camera connection is a CCTV connection and is configured to illuminate the workspace.

10. System for maintenance and inspection of structures according to claim 1, wherein said control centre controls the movement of the arm.

11. System for maintenance and inspection of structures according to claim 10, wherein said control centre provides the arm with power for operation.
